(19) United States
(12) Patent Application Publication
(10) Pub. No.: US 2007/0216713 A1
(43) Pub. Date: Sep. 20, 2007

(54) Controlled topology tweaking in solid models

(75) Inventor: Jiri Kripac, Fairfax, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: Autodesk, Inc.

(21) Appl. No.: 11/376,654

(22) Filed: Mar. 15, 2006

(51) Int. Cl. G09G 5/00

(52) U.S. Cl. 345/678

(57) ABSTRACT

A method, apparatus, and article of manufacture provide the ability to motify a three-dimensional model. A 3D model is displayed in a computer implemented solid modeling system. A vector is selected that is comprised of one or more first faces, first edges, or first vertices of the three-dimensional model. One or more options that control a behavior of a repositioning operation for each face, edge and vertex in the vector are specified. One or more geometric transformations are specified for each face, edge and vertex in the vector. The 3D model is modified by changing one or mote surfaces of one or more second faces in accordance with the options and the geometric transformations. Intersections are determined for of the changed one or more surfaces. New edges and new vertex coordinates are then obtained for the three-dimensional model based on the intersections.

### CROSS-REFERENCE TO RELATED APPLICATIONS

This application is related to the following co-pending and commonly-assigned patent(s) and patent application(s), which patents and applications are incorporated by reference herein:

U.S. Pat. No. 6,867,771, issued on Mar. 15, 2005, and filed on May 7, 2002, entitled “CONTROLLED FACE DRAGGING IN SOLID MODELS”, by jiri Kripac, Attorney Docket No. G&C 30566.229-US-01.

U.S. patent application Ser. No. 10/132,544, filed on Apr. 25, 2002, entitled “FACE MODIFICATION TOOL”, by Sha Wang, William L. Myers, and John R. Wallace, Attorney Docket No. G&C 30566.216-US-U1.

### BACKGROUND OF THE INVENTION

1. Field of the Invention

The present invention relates generally to three-dimensional modeling systems based on boundary representations, and in particular, to a method, apparatus, and article of manufacture for the controlled transforming of faces, edges, and vertices in boundary representations and solid bodies.

2. Description of the Related Art

The use of solid modeling application programs is well known in the art. In a 3D solid modeling system, a 3D model (also referred to as an object model) may be constructed, displayed, modified, etc. A solid model may be presented to the user by displaying the boundary of the model (referred to as a boundary representation or B-rep). Further, the boundary representation has multiple individual faces. To manipulate/modify the model, a face, edge, or vertex of the boundary representation may be dragged/repositioned using a cursor control device such as a mouse. However, when a single face, edge, or vertex is moved, adjacent faces, edges, or vertices (e.g., faces that share common edges and vertices with the face, edge, or vertex being moved) may become invalid. For example, an adjacent face that was originally planar may become non-planar when vertices shared between a moved face and adjacent face are repositioned (such that the vertices of the adjacent face do not lie on the same plane any more).

Additionally, in prior art solid modeling application programs, the user cannot control how adjacent faces should be adjusted during a face, edge, or vertex movement operation. For example, without input from the user, a solid modeling application program may adjust adjacent faces in a predetermined manner during a face, edge, or vertex movement operation. Thus, the user is not provided with any option(s) and does not have the capability to control or elect between multiple different types of face, edge, or vertex movement operations.

Accordingly, what is needed is a method, system, and article of manufacture for tweaking/transforming a face, edge, or vertex of a boundary representation while providing the user with options to control the tweaking/transforming operation.

### SUMMARY OF THE INVENTION

To overcome the problems of the prior art, embodiments of the invention provide the ability to modify/tweak/transform a 3D model using faces, edges, or vertices. The user has the option of specifying for each tweaked face and edge whether its bundary is to be preserved during a repositioning operation. The boundary of a face is the edges and vertices of the face while the boundary of an edge is the two end vertices of the edge. If the boundary is preserved, the shape and size of the face or edge is preserved while the planes of the planar adjacent faces are changed to accommodate the tweak/transformation operation. If the boundary is not preserved, size and shape of the face or edge may not be preserved and will change while the surfaces of incident faces are maintained. Accordingly, the edges and vertices may change to accommodate the tweak/transformation operation.

The underlying capability to modify the 3D model provides for changing faces of the 3D solid based on the boundary preservation setting and the geometric transformation/tweak operation. Intersections of the changed faces are determined thereby providing new edges and new vertex coordinates for the modified 3D model.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 is a block diagram that illustrates the components of the solid modeling program in accordance with one or more embodiments of the invention;

FIG. 3 is a block diagram that illustrates the structure of an object list maintained by the 3D databases in accordance with one or more embodiments of the invention;

FIG. 4 illustrates the input to and output from solid modeling program during a tweaking/transforming operation in accordance with one or more embodiments of the invention;

FIGS. 5A-5I illustrate examples of the behavior of a tweaking/transforming operation for a face or edge of a truncated pyramid in accordance with one or more embodiments of the invention;

FIGS. 6A-6C illustrate the effect of a preserve boundary option when rotating a top face of an E-shaped B-rep solid in accordance with one or more embodiments of the invention;

FIGS. 7A-7C illustrate the effect of a face triangulation option when moving a vertex of an octagonal solid in accordance with one or more embodiments of the invention; and

FIG. 8 is a flowchart illustrating a controlled topology tweaking operation in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Overview

A method, apparatus, and article of manufacture provide for the ability to edit solid models, intuitively, in a manner that was difficult or time-consuming to perform in the prior art. Embodiments provide a mechanism for editing boundary represented solid models by tweaking/transforming its selected faced, edges, and vertices. An option allows the user to control the behavior of the tweak/transformation operation and to choose between possible solutions. Accordingly, users can be more productive in developing 3D models.

Hardware and Software Environment

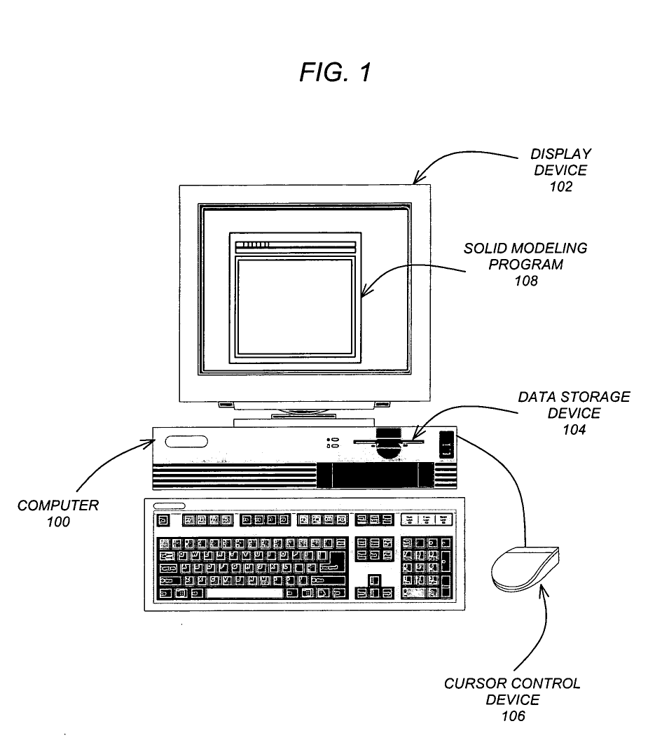

FIG. 1 is an exemplary hardware and software environment used to implement one or more embodiments of the invention. Embodiments of the invention are typically implemented using a computer 100, which generally includes, inter alia, a display device 102, data storage devices 104, cursor control devices 106, and other devices. Those skilled in the art will recognize that any combination of the above components, or any number of different components, peripherals, and other devices, may be used with the computer 100.

One or more embodiments of the invention are implemented by a computer-implemented solid modeling program 108, wherein the solid modeling program 108 is represented by a window displayed on the display device 102. Generally, the solid modeling program 108 comprises logic and/or data embodied in or readable from a device, media, carrier, or signal, e.g., one or more fixed and/or removable data storage devices 104 connected directly or indirectly to the computer 100, one or more remote devices coupled to the computer 100 via a data communications device, etc.

Those skilled in the art will recognize that the exemplary environment illustrated in FIG. 1 is not intended to limit the present invention. Indeed, those skilled in the art will recognize that other alternative environments may be used without departing from the scope of the present invention.

Computer-Implemented Solid Modeling Program

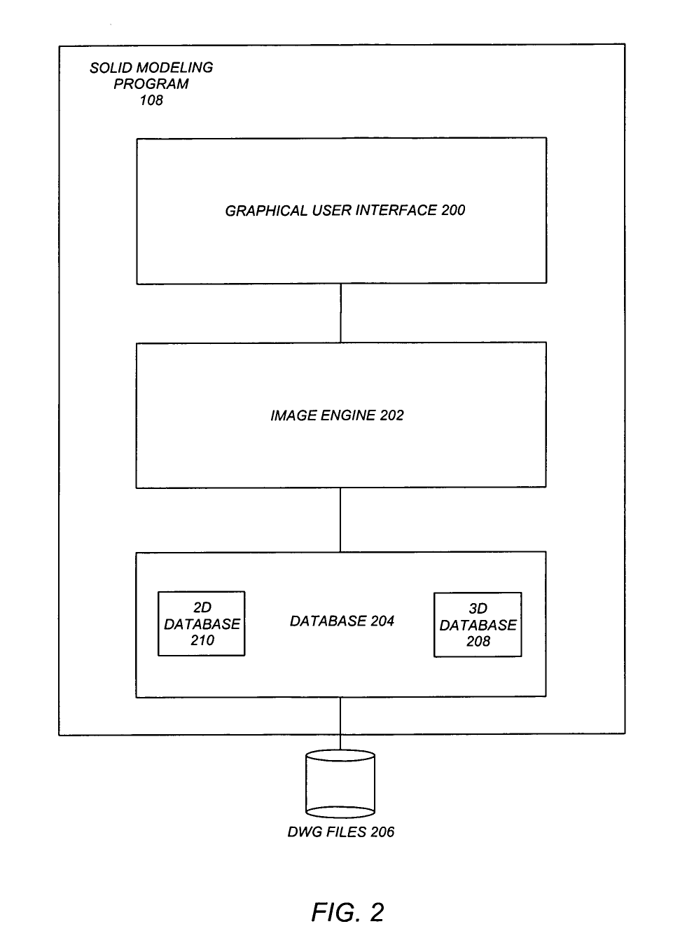

FIG. 2 is a block diagram that illustrates the components of the solid modeling program 108 in accordance with one or more embodiments of the invention. There are three main components to the solid modeling program 108, including: a Graphical User Interface (GUI) 200, an Image Engine (IME) 202, and a DataBase (DB) 204 for storing objects in Drawing (DWG) files 206.

The Graphical User Interface 200 displays information to the operator and provides the functionality for the operator's interaction with the solid modeling program 108.

The Image Engine 202 processes the DWG files 206 and delivers the resulting graphics to the monitor 102 for display. In one or more embodiments, the Image Engine 202 provides a complete application programming interface (API) that allows other computer programs to interface to the solid modeling program 108 as needed.

The Database 204 is comprised of two separate types of databases: (1) a 3D database 208 known as the “3D world space” that stores 3D information; and (2) one or more 2D databases 210 known as the “2D view ports” that stores 2D information derived from the 3D information.

Object List

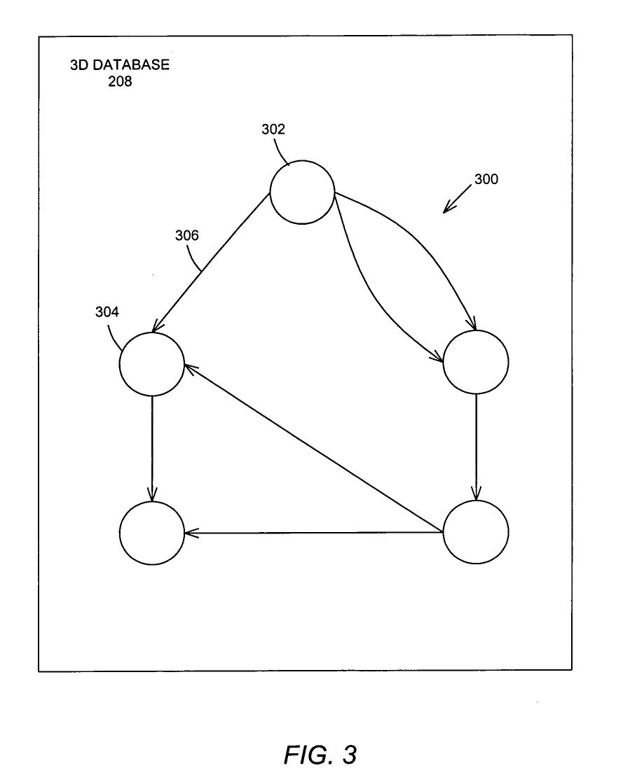

FIG. 3 is a block diagram that illustrates the structure of an object list 300 maintained by the 3D databases 208 in accordance with one or more embodiments of the invention. The object list 300 is usually comprised of a doubly linked list having a list head 302 and one or more objects 304 interconnected by edges 306, although other structures may be used as well. There may be any number of different object lists 300 maintained by the 3D databases 208. Moreover, an object 304 may be a member of multiple object lists 300 in the 3D databases 208.

Operation of the Software Embodiment

One or more embodiments of the invention provides a new method within solid modeling program 108 for repositioning individual faces, edges, and/or vertices in a topological structure of boundary representation solid bodies, such as during the dragging (e.g., grip-point editing) of faces, edges, or vertices in solid bodies. Multiple options are introduced to control the behavior of the repositioning/transformation operation. The options are selectable by the user (e.g., through a selectable option), who thus controls the outcome of the tweak/transformation operation.

One option determines whether the boundary of a face or edge should be preserved or not. Such an option indicates whether only the entity “geometry” is to be tweaked/transformed or whether the entity “boundary” is to be tweaked/transformed as well. The entity geometry is defined herein as the surface of the face and the curve of the edge. The boundary of a face is defined as the edges and vertices of the face. The boundary of an edge is defined as the two end vertices of the edge.

A second option controls what occurs when planar faces would become distorted as a result of some of its edges and/or vertices being tweaked/transformed. Either the planes of such faces may be changed to accommodate the tweaked edges and vertices or the faces may be triangulated.

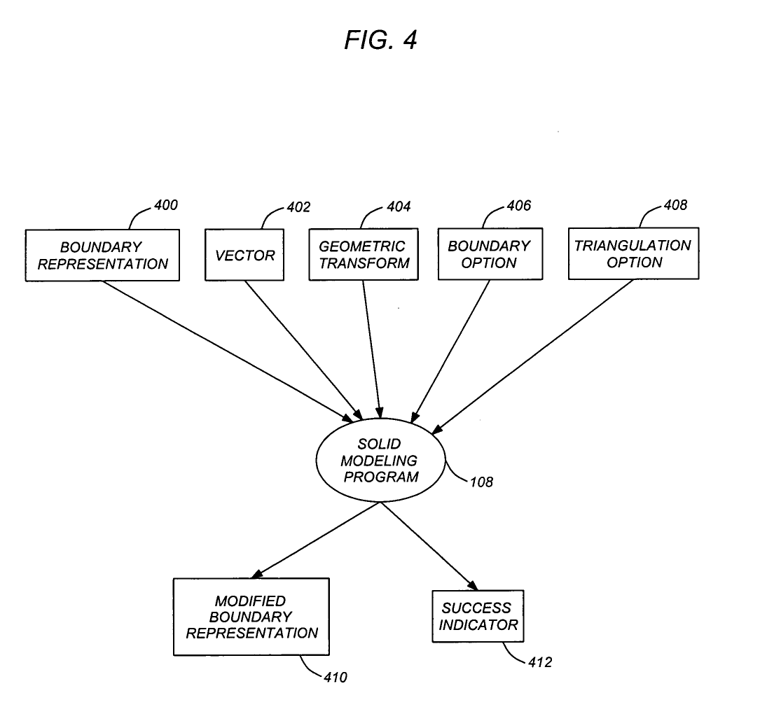

FIG. 4 illustrates the input to and output from solid modeling program 108 during a tweaking/transforming operation in accordance with one or more embodiments of the invention. The solid modeling program 108 takes inputs 400-408 and provides output 410-412. The three-dimensional (3D) solid modeling boundary representation 400 (also referred to as B-rep solid) is one of the inputs used by the solid modeling program 108. The 3D model may have many faces, edges, and vertices. Such faces may be planar faces or non-planar faces such as cylindrical, spherical, etc. In addition, a vector 402 of selected faces, edges, and vertices of the B-rep solid 400 and the tweak/transformation (geometric transformation) 404 for each selected face, edge, and vertex are used as input. The tweak/transformation may comprise a variety of geometric movements including translation, rotation, scaling, etc.

Additional input may include the boundary option 406 (also referred to as the tweak/boundary option) for each selected face and edge. The boundary option indicates whether only the entity “geometry” is to be tweaked or whether also the entity “boundary” is to be tweaked. As described above, the entity geometry is defined as the surface of the face and the curve of the edge. The boundary of a face is defined as the face's edges and vertices. The boundary of an edge is defined as the two end vertices of the edge.

The triangulation option 408 determines and controls what occurs when planar faces would become distorted as a result of some of the edges and/or vertices being tweaked/transformed. Either the planes of such faces may be changed to accommodate the tweaked edges and vertices or the faces may be triangulated.

After the transformation is performed, the solid modeling program 108 will output the modified boundary representation 410 and a success indicator 412 (e.g., a flag indicating the success or failure of the transformation operation).

Various limitations may also be imposed on which edges and vertices of a B-rep solid model may be tweaked/transformed so that the result of the tweak/transformation may be more predictable. For example, any face may be tweaked/transformed. However, there may be a lamitation such that edges are tweakable if they are linear and have at least one planar incident face. A further limitation may provide that vertices are tweakable if they have at least one planar incident face. Such limitations will provide a more predictable and user-friendly/intuitive manner for editing/transforming B-rep solid models.

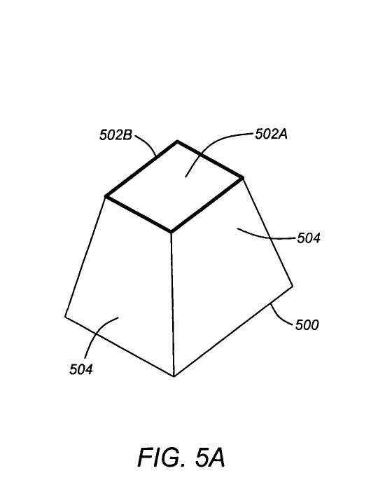

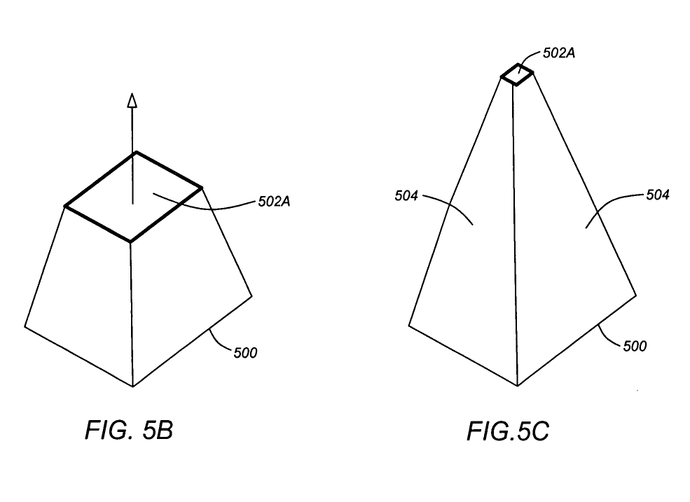

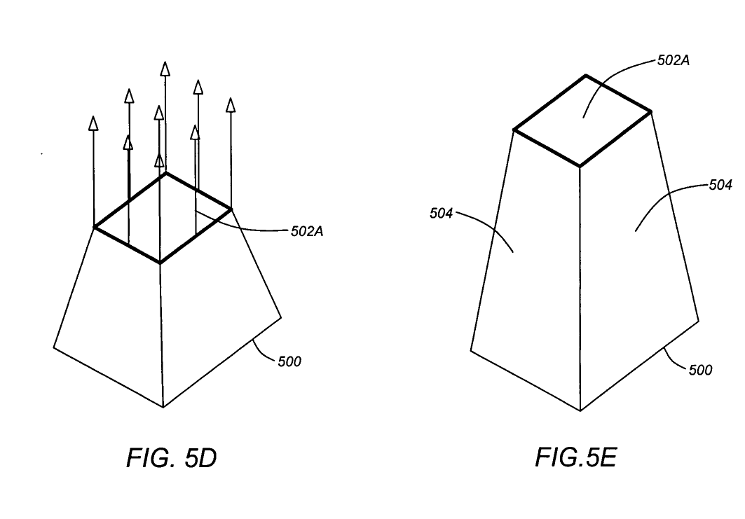

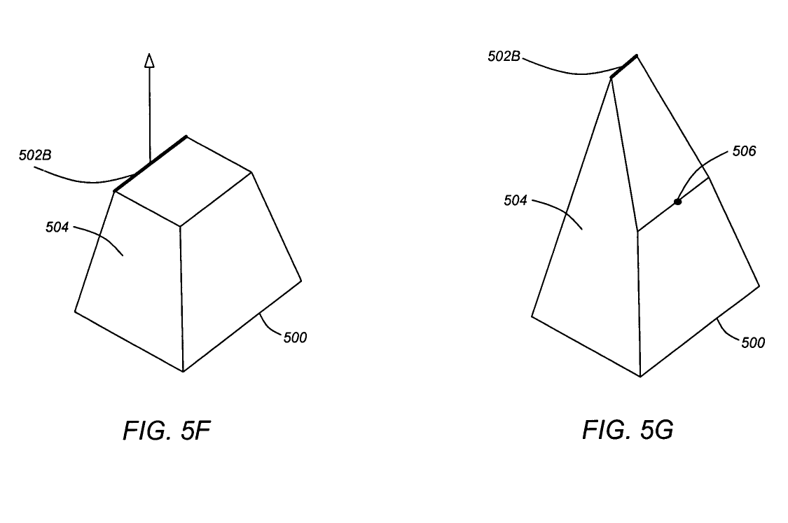

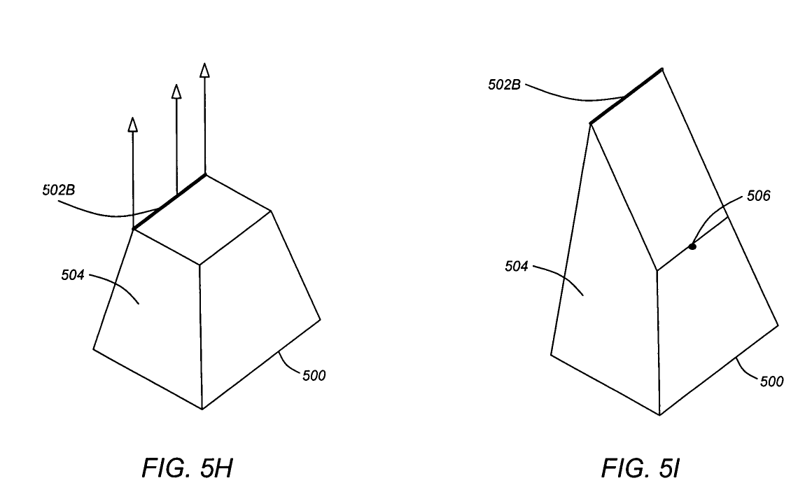

FIGS. 5A-5I illustrate examples of the behavior of a tweaking/transforming operation for a face or edge of a truncated pyramid in accordance with one or more embodiments of the invention. FIG. 5A illustrates an original pyramid 500 whose top face 502A or top edge 502B is to be moved upwards.

FIG. 5B illustrates the direction the surface of face 502A will be moved when the boundary option 406 is false (i.e., without preserving the boundary). Without preserving the boundary, the boundary of the tweaked face 502A will change. Accordingly, only the surface of the tweaked face 502A is moved. The tweaked face edges (e.g., including edge 502B) are obtained by reintersecting the tweaked face surface 502A with the side face surfaces 504. The side face surfaces remain unchanged but the shape of the tweaked face 502A changes. FIG. 5C illustrates the result of the transformation after dragging/tweaking the face 502A without preserving the boundary. As illustrated, the planes of the adjacent faces 504 are not changed. Instead, the shape of face 502A (i.e., the face being moved) is changed.

FIG. 5D illustrates the direction the surface of face 502A, as well as its edges and vertices, will be moved when the boundary option 406 is true (i.e., while preserving the boundary). FIG. 5E illustrates the result of the operation after dragging the face 502A while preserving the boundary. With such an option, the shape of the face 502A remains the same and adjacent faces need to adjust to hold/maintain the shape of the face 502A. Accordingly, as illustrated, the geometry of face 502A (i.e., the face being moved) is not changed. Instead, the planes of the adjacent faces 504 are changed. Thus, the surface of the tweaked face 502A, as well as its edges and vertices, are moved. The shape of the tweaked face 502A remains constant (i.e., stays unchanged), by the planes of the side faces are adjusted.

FIG. 5F illustrates the direction the curve (straight line) of edge 502B will be moved when the boundary option 406 is false (i.e., without preserving the boundary). FIG. 5G illustrates the result of the operation after dragging the edge 502B without preserving the boundary. As illustrated, only the straight line of the tweaked edge 502B is moved. The planes of the two faces incident on the tweaked edge 502B are adjusted to contain the tweaked edge 502B. The end vertices of the tweaked edge 502B are obtained by reintersecting the surfaces. The surfaces of the faces 504 at the ends of the edge 502B stay unchanged, but the length of the tweaked edge 502B changes.

FIG. 5H illustrates the direction the curve (straight line) of edge 502B, as well as its end vertices, will be moved when the boundary option 406 is true (i.e., while preserving the boundary). FIG. 5I illustrates the results of the operation after dragging the edge 502B while preserving the boundary. As illustrated the straight line of the tweaked edge 502B, as well as its end vertices (i.e., its boundary), are moved. The planes 504 of the faces incident on the tweaked edge 502B and on its end vertices are adjusted to contain the tweaked edge 502B and its tweaked vertices. The length of the tweaked edge 502B stays unchanged.

Thus, when tweaking an edge, the 3D model is modified by repositioning the edge. If the boundary is specified to be preserved, the selected edge and end vertices of the selected edge are moved/transformed, a length of the selected edge is not changed, and planes of faces incident on the selected edge and on the end vertices of the selected edge are adjusted. However, if the boundary is specified not to be preserved, a curve (i.e., straight line) of the selected edge is moved/transformed, planes of faces incident on the selected edge are adjusted to contain the selected edge, and surfaces of faces at ends of the selected edge are unchanged.

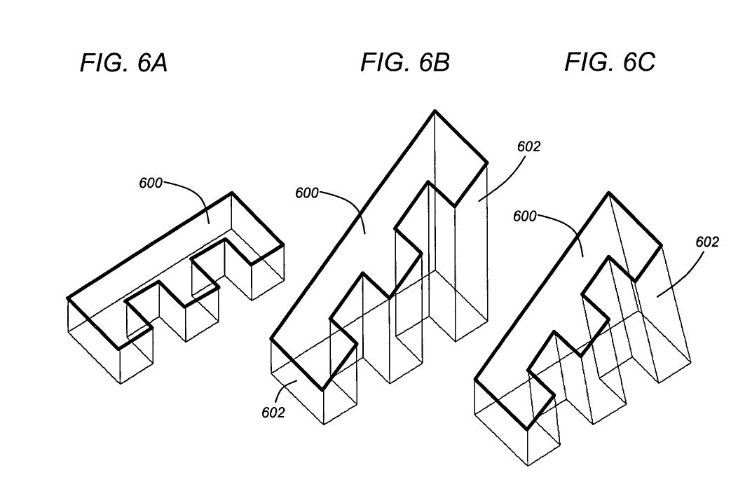

FIGS. 6A-6C illustrate the effect of a preserve boundary option when rotating a top face of an E-shaped B-rep solid in accordance with one or more embodiments of the invention. FIG. 6A is an E-shaped B-rep solid whose top face 600 is to be tweaked.

FIG. 6B illustrates a rotation of the top face 600 when the boundary option is false (i.e., without preserving the boundary). Only the surface of the tweaked face 600 is rotated. Tweaked face edges are obtained by reintersecting the tweaked face surface 600 with the side face surfaces 602. The side face surfaces stay unchanged but the shape of the tweaked face 600 changes. In other words, the boundary of the tweaked face 600 is not preserved but is adjusted to accommodate the rotation while the planes of the side surfaces are maintained.

FIG. 6C illustrates a rotation of the top face 600 when the boundary option is true (i.e., while preserving the boundary). The surface of the top face 600, as well as the edges and vertices of the top face 600, are rotated. The shape of the tweaked face 600 stays unchanged, but the planes of the side faces 602 are adjusted. Thus, as illustrated, the boundary of the top face 600 (i.e., the edges and vertices) is preserved and the shape and size of the top face 600 is maintained. However, the side faces 602 are adjusted to accommodate the top face boundary. Thus, the planes of the side faces 602 are tilted/adjusted to accommodate the rotation of the top face.

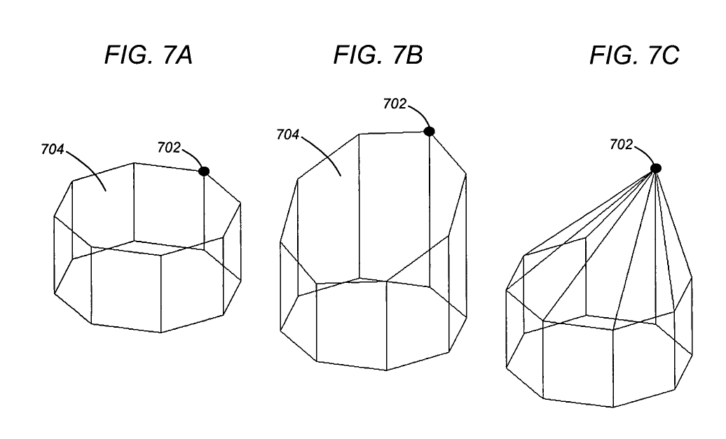

FIGS. 7A-7C illustrate the effect of a face triangulation option when moving a vertex of an octagonal solid in accordance with one or more embodiments of the invention. FIG. 7A illustrates an octagonal solid having a vertex 702 that is to be moved in accordance with one or more embodiments of the invention.

FIG. 7B illustrates a transformation operation of the vertex 702 when face triangulation is not requested. Namely, the plane of the top face 704 is adjusted to contained the tweaked vertex 702. The edges and vertices of the top face 704 are obtained by reintersecting the changed face plane with other face surfaces.

FIG. 7C illustrates a transformation operation of the vertex 702 when face triangulation is requested in accordance with one or more embodiments of the invention. As illustrated, the top face 704 is triangulated based on the new location of the vertex 702.

Logic of the Graphics Program

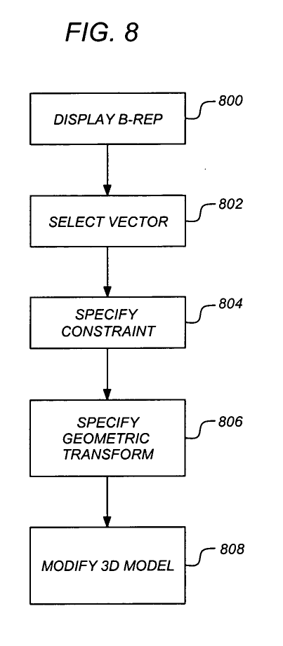

FIG. 8 is a flowchart illustrating a controlled topology tweaking operation in accordance with one or more embodiments of the invention. At step 800, a B-rep of a 3D model is displayed in a computer-implemented solid modeling system. At step 802, a vector is selected. Such a vector is comprised of one or more first faces, first edges, or first vertices of the 3D model. Accordingly, the selected vector may comprise multiple faces, edges, or vertices.

At step 804, one or more options that control a behavior of a repositioning operation are specified for each face, edge (and possibly a vertex) in the vector. One type of such option(s) controls whether the boundary(ies) of each face(s) and/or edge(s) in the vector is preserved or not. In this regard, the boundary of a face comprises the face edges and face vertices. The boundary of an edge comprises end vertices of the edge. Accordingly, the user may specify whether the boundary is to be preserved for each face and/or edge in the vector. The specifying of the options at step 804 may also include specifying a triangulation option that determines how to accommodate the tweaked edges and tweaked vertices. In this regard, the planes of the planar faces incident at the tweaked edges and vertices (also referred to as surfaces of one or more second faces) may be changed. Alternatively, the planar/second faces are triangulated.

At step 806, a geometric transformation (tweak transformation) for each face, edge and vertex in the vector is specified.

Step 808 provides for modifying the B-rep of the 3D model in accordance with the options and geometric transformations. To modify the model, one or more surfaces of one or more second faces of the 3D solid are changed in accordance with the options and the one or more geometric transformations. Such faces that are changed may be the face that is tweaked or the adjacent faces depending on the setting of the boundary option and whether a face, edge, or vertex is being tweaked. The tweaking is further performed by determining intersections of the changed surfaces, obtaining/determining new edges for the 3D model based on the intersections, and obtaining/determining new vertex coordinates for the 3D model based on the intersections.

Referring now to FIGS. 4 and 8, the system 108 performs the tweaking at step 808 by changing the surfaces of the faces (planar or non-planar) in the B-rep solid 400, reintersecting the changed face surfaces, obtaining new edge curves and vertex coordinates. Thereafter, if the result 410 is a valid B-rep solid, the input B-rep solid is modified and a success error status 412 is returned. Otherwise, the input B-rep solid 400 is left unchanged and an error status 412 is returned.

For faces in the vector 402 the surfaces of those faces are transformed at step 808 by the given tweak transformations. When the boundary option for a face is on, i.e. the face boundary is to be tweaked also, the edges and vertices of the face are also tweaked as if they were added to the input vector.

For edges in the vector 402, the planar/second faces (and not the non-planar faces) incident on those edges are modified to contain the edge curves (straight lines) after the transformation 404. Based on the input triangulation option 408, such a modification may mean either triangulating the incident planar faces or transforming their planes. When the planar faces incident on the edge need to be transformed, rigid motion transformations may be calculated that transforms the original planes of the planar faces to new planes, so that the new planes contain the edges after the tweak. When the boundary option for an edge is on, i.e. the edge boundary is to be tweaked also, the edge end vertices are also tweaked as if they were added to the input vector. In this regard, non-planar faces incident on the edges may not be modified.

To define the new plane, a most distant point on the face boundary to the tweaked edge is found. Such a point may be used as the fixed point whose position stays unchanged after modifying the planes of the planar face. Choosing the most distant point minimizes face “wobble”. For example, FIGS. 5G and 5I illustrate such a fixed distant point 506 that may be used to define the new plane of the face incident to the edge 502B.

For vertices in the vector 402, the planar/second faces (and not the non-planar faces) incident on the vertices are modified to contain the vertices after the transformation 404. Based on the input triangulation option, such a modification may comprise triangulating the incident planar faces or transforming their planes.

Similar to tweaking an edge, if the incident planar faces need to be transformed, rigid motion transformations may be calculated that transform the original planes of the planar faces to the new planes, so that the new planes contain the vertices after the tweak. To define the new plane, a most distant point on the face boundary to the tweaked vertex may be found, and this point is used as the fixed point whose position remains constant (i.e., unchanged) after the face transformation. Choosing the most distant point minimizes the face “wobble”.

Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for modifying a three-dimensional model, comprising:
(a) displaying a three-dimensional model in a computer implemented solid modeling system;
(b) selecting an edge of the three-dimensional model;
(c) specifying whether a boundary of the edge is to be preserved during a repositioning operation of the edge;
(d) modifying the three-dimensional model by repositioning the selected edge, wherein:
(i) if the boundary is specified to be preserved, the selected edge and end vertices of the selected edge are transformed, a length of the selected edge is not changed, and planes of faces incident on the selected edge and on the end vertices of the selected edge are adjusted; and
(ii) if the boundary is specified not to be preserved, a curve of the selected edge is transformed, planes of faces incident on the selected edge are adjusted to contain the selected edge, and surfaces of faces at ends of the selected edge are unchanged.

2. A method for modifying a three-dimensional model, comprising:
(a) displaying a three-dimensional model in a computer implemented solid modeling system;
(b) selecting a vector comprised of one or more first faces, first edges, or first vertices of the three-dimensional model;
(c) specifying one or more options that control a behavior of a repositioning operation for each first face, first edge and first vertex in the vector;
(d) specifying one or more geometric transformations for each first face, first edge and first vertex in the vector;
(e) modifying the three-dimensional model by:
(i) changing one or more surfaces of one or more second faces of the three-dimensional solid in accordance with the one or more options and the one or more geometric transformations;
(ii) determining intersections of the changed one or more surfaces;
(iii) obtaining new edges for the three-dimensional model based on the intersections; and
(iv) obtaining new vertex coordinates for the three-dimensional model based on the intersections.

3. The method of claim 2 wherein one or more of the options provides for preserving a boundary of the first face or first edge of the vector.

4. The method of claim 3 wherein the boundary of the first face comprises face edges and face vertices of the first face.

5. The method of claim 3 wherein the boundary of the first edge comprises end vertices of the first edge.

6. The method of claim 5 wherein:
the one or more second faces comprise planar faces incident on the first edge; and
planes of the planar faces are modified to contain the first edge.

7. The method of claim 6 wherein the planar faces are modified by:
determining a most distant point on a boundary of the planar face from the first edge; and
using the most distant point as a fixed point with a position that does not change after modifying the planes of the planar faces.

8. The method of claim 2 wherein:
the vector comprises the first vertex;
the one or more second faces comprise planar faces incident on the first vertex; and
planes of the planar faces are modified to contain the first vertex.

9. The method of claim 2 wherein the one or more second faces are incident to each first face, first edge, and first vertex in the vector, and wherein the method further comprises specify a triangulation option that determines whether the changed one or more second faces are changed by triangulation, or whether planes of the one or more second faces are changed to accommodate the new edges and new vertex coordinates.

10. A computer-implemented system comprising:
(a) a three-dimensional model displayed in a solid modeling system, wherein the model comprises a vector comprised of one or more first faces, first edges, or first vertices of the three-dimensional model;
(b) a method for modifying the one or more first faces, first edges and first vertices in the vector, wherein the method is configured to:
(i) select the vector;
(ii) specify one or more options that control a behavior of a repositioning operation for each first face, first edge and first vertex in the vector;
(iii) specify a geometric transformation for each first face, first edge and first vertex in the vector;
(iv) modify the three-dimensional model by:
(1) changing one or more surfaces of one or more second faces of the three-dimensional solid in accordance with the one or more options and the one or more geometric transformations;
(2) determining intersections of the changed one or more surfaces;
(3) obtaining new edges for the three-dimensional model based on the intersections; and
(4) obtaining new vertex coordinates for the three-dimensional model based on the intersections.

11. The system of claim 10 wherein one or more of the options provide for preserving a boundary of the first face or first edge of the vector.

12. The system of claim 11 wherein the boundary of the first face comprises face edges and face vertices of the first face.

13. The system of claim 11 wherein the boundary of the first edge comprises end vertices of the first edge.

14. The system of claim 13 wherein:
the one or more second faces comprise planar faces incident on the first edge; and
planes of the planar faces are modified to contain the first edge.

15. The system of claim 14 wherein the planar faces are modified by:
determining a most distant point on a boundary of the planar face from the first edge; and
using the most distant point as a fixed point with a position that does not change after modifying the planes of the planar faces.

16. The system of claim 10 wherein:
the vector comprises the first vertex:
the one or more second faces comprise planar faces incident on the first vertex; and
planes of the planar faces are modified to contain the first vertex.

17. The system of claim 10 wherein the one or more second faces are incident to each first face, first edge, and first vertex in the vector, and wherein the method further comprises specifying a triangulation option that determines whether the changed one or more second faces are changed by triangulation, or whether planes of the one or more second faces are changed to accommodate the new edges and new vertex coordinates.

18. An article of manufacture comprising a program storage medium readable by a computer and embodying logic executable by the computer to perform a method for modifying a three-dimensional model, wherein the method comprises:
(a) displaying a three-dimensional model in a computer implemented solid modeling system;
(b) selecting a vector comprised of one or more first faces, first edges, or first vertices of the three-dimensional model;
(c) specifying one or more options that control a behavior of a repositioning operation for each first face, first edge and first vertex in the vector;
(d) specifying one or more geometric transformations for each first face, first edge and first vertex in the vector;
(c) modifying the three-dimensional model by:
(i) changing one or more surfaces of one or more second faces of the three-dimensional solid in accordance with the one or more options and the one or more geometric transformations;
(ii) determining intersections of the changed one or more surfaces;
(iii) obtaining new edges for the three-dimensional model based on the intersections; and
(iv) obtaining new vertex coordinates for the three-dimensional model based on the intersections.

19. The article of manufacture of claim 18 wherein the one or more options provide for preserving a boundary of the first face or first edge of the vector.

20. The article of manufacture of claim 19 wherein the boundary of the first face comprises face edges and face vertices of the first face.

21. The article of manufacture of claim 19 wherein the boundary of the first edge comprises end vertices of the first edge.

22. The article of manufacture of claim 21 wherein:
the one or more second faces comprise planar faces incident on the first edge; and
the planar faces are modified to contain the first edge.

23. The article of manufacture of claim 22 wherein the planar faces are modified by:
determining a most distant point on a boundary of the planar face from the first edge; and
using the most distant point as a fixed point with a position that does not change after modifying the planes of the planar faces.

24. The article of manufacture of claim 18 wherein:
the vector comprises the first vertex;
the one or more second faces comprise planar faces incident on the first vertex; and
planes of the planar faces are modified to contain the first vertex.

25. The article of manufacture of claim 18 wherein the one or more second faces are incident to each first face, first edge, and first vertex in the vector, and wherein the method further comprises specifying a triangulation option that determines whether the changed one or more second faces are changed by triangulation, or whether planes of the one or more second faces are changed to accommodate the new edges and new vertex coordinates.
